(19) United States
(12) Patent Application Publication
(10) Pub. No.: US 2003/0192227 A1
(43) Pub. Date: Oct. 16, 2003

(54) Elastomeric lure for retaining fish attracting articles

(75) Inventors: William John Stava III, Tulsa, OK (US); Alan W. McGuckin, Skiatook, OK (US); Kyle R. Thorsen, Tulsa, OK (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Outdoor Innovations, LLC

(21) Appl. No.: 10/120,675

(22) Filed: Apr. 11, 2002

(51) Int. Cl. A01K 85/00

(52) U.S. Cl. 43/42.24

(57) ABSTRACT

A lure having an elastomeric body is provided. The body defines an aperture structured to retain a replaceable fish attracting article, such as an illuminant, scent packet, rattle, gas emitter, or weight. The body of the lure can be constructed of a crystal gel having improved damage tolerance, crack propagation resistance, tear resistance and fatigue resistance, which greatly minimizes the risk of tearing during insertion, removal and reinsertion of the fish attracting articles. The aperture has an entrance portion and a retaining portion. The entrance portion and retaining portion define at least one shoulder that structured to retain the fish attracting article in the retaining portion.

### FIELD OF THE INVENTION

The present invention is related to the field of artificial bait used to catch fish, and more particularly, elastomeric lures for retaining fish attracting articles.

### BACKGROUND OF THE INVENTION

Anglers frequently use artificial bait or lures as an alternative to live bait. Among other drawbacks, live bait is perishable, can be difficult to attach to a hook prior to casting and can be prone to loss after casting. In contrast, artificial bait has the advantages of an extended shelf life and of being easily and securely attached to a hook. Despite the advantages of artificial bait, live bait is still widely used due to its effectiveness in attracting fish. It is generally believed that the effectiveness of live bait is due to the difficulty of “fooling” fish, which can have sophisticated visual, aural, olfactory, and/or vibratory sensory capabilities. Such acute sensory capabilities enable the fish to detect even minute differences between live and artificial bait. Further, the increase of catch-and-release fishing has resulted in the released fish becoming increasingly wary of bait not closely resembling their typical food.

Improvements in artificial bait, therefore, have mainly focused on increasing the attractiveness of artificial bait to the fish. Such improvements have included the use of soft elastomers, such as plastisol, that can be shaped to resemble live bait, as well as the use of glitter, illuminants, such as light sticks, metal spoons and spinners, scent packets and rattles. Soft elastomers have the advantage of giving the fish a tactile sensation similar to the flesh of live bait. Glitter, metal spoons, and illuminants create visual stimuli resembling the flash of sunlight on the scales of moving bait fish. Scent packets replicate the smell of prey or food that the fish finds desirable. Rattles mimic the sounds and vibratory patterns of prey, such as the clicking of a crawfish.

Recently, efforts have been made to combine various fish attracting characteristics into a single artificial lure. For example, U.S. Pat. No. 4,203,246 to Sacharnoski, Sr. discloses a rattle comprising a plurality of metal balls enclosed within a glass capsule with crimped, pointed ends to allow its insertion through a slit cut into a soft-bodied lure. Despite combining the feel of a soft plastic lure with the sound enhancement of a rattle, the slit into which the rattle is inserted has a tendency to enlarge through creep. In addition to damaging the lure, enlargement of the slit incurs the risk of losing the rattle during casting or while retrieving a fish. Cutting the soft-bodied lure for insertion of the rattle can also be a difficult and frustrating process to perform in an outdoor environment.

U.S. Pat. No. 6,041,540 to Potts discloses a soft plastic fishing lure in the shape of a fish having a preformed rattle 21 or scent chamber 12, which comprises an elongate void space or slot positioned on its dorsal side. The preformed slot allows the angler to alternate between a rattle or a scent packet without having to form a slit in the body of the fishing lure. The rattle or scent packet is held in position by the frictional force exerted by the surrounding soft plastic. However, as with the lure disclosed in the Sacharnoski '246 patent, the rattle or scent packet has a tendency to come loose from the slot 12 of the Potts '540 patent, particularly when the lure is subjected to vigorous casting or the thrashing movement of a hooked fish.

U.S. Pat. No. 5,725,892 to Gibbs discloses a flexible plastic fishing worm 10 having a cavity 20 in its abdominal region accessible by two pinholes 24 and 26. A fish-attracting scent gel can be injected into one of the pinholes to fill the cavity, while the other pinhole relieves the pressure increase in the cavity caused by the injection. Advantageously, the small size of the pinholes reduces the rate of leakage of the scent gel from the cavity. In addition to the scent gel, the Gibbs '892 patent discloses positioning a noise maker in the cavity. However, because the pinholes have relatively small diameters to provide for a slow release of the scent gel, the pinholes are susceptible to tearing when attempting to insert a solid object therethrough.

Accordingly, it would be advantageous to have a soft bodied fishing lure with which can be employed various fish attracting articles, such as illuminants, scent packets or rattles. It would be further advantageous if the angler could easily alternate between fish attracting articles. In addition, it would be advantageous if the fish attracting articles were easily attached to the lure without risking loss of the fish attracting article during casting. It also would be advantageous if attachment of the fish attracting articles to the lure could be accomplished without tearing the soft body of the lure.

### SUMMARY OF THE INVENTION

The present invention addresses the above needs and achieves other advantages by providing a lure having an elastomeric body defining an aperture structured to retain a fish attracting article, such as an illuminant, a scent packet, a rattle, a gas emitter, or a weight. The elastomeric body can comprise a variety of configurations, including a salamander-like configuration or a fish-like configuration. In one embodiment, the elastomeric body defines a plurality of streamers extending therefrom that conceal the aperture. In another embodiment, the elastomeric body of the lure is constructed of a crystal gel having improved properties over conventional soft plastics, including an improved resistance to tearing, which greatly minimizes the risk of damaging the elastomeric body during insertion, removal and reinsertion of fish attracting articles. The aperture defined by the elastomeric body is structured to receive the fish attracting article without tearing and to retain the fish attracting article even during vigorous casting or retrieving a thrashing fish. For elastomeric bodies comprising a fish-like or salamander-like configuration, the aperture can be positioned on the abdomen so that the aperture has an anatomically correct appearance.

According to one embodiment of the present invention, the elastomeric body defines an aperture having an entrance portion and a retaining portion. The entrance portion has an end coincident with one end of the retaining portion and is structured to allow passage of the fish attracting article therethrough into the retaining portion. The axis of the entrance portion is disposed angularly relative to the axis of the retaining portion to thereby retain the fish attraction article in the retaining portion. In one embodiment, the axis of the entrance portion is disposed at an angle of between about 0° and 90° relative to the axis of the retaining portion.

According to another embodiment of the present invention, the elastomeric body defines an aperture having an entrance portion and a retaining portion. The entrance portion has a diameter approximately equal to the diameter of the retaining portion and is structured to allow passage of the fish attracting article therethrough into the retaining portion. The axis of the entrance portion is disposed angularly relative to the axis of the retaining portion to thereby retain the fish attracting article in the retaining portion. In one embodiment, the axis of the entrance portion is disposed at an angle of between about 0° and 90° relative to the axis of the retaining portion.

According to another embodiment of the present invention, the lure comprises an elongate elastomeric body defining an aperture having an entrance portion and a retaining portion. The entrance portion of the aperture extends from one end of the elongate elastomeric body to one end of the retaining portion. The diameter of the entrance portion is smaller than the diameter of the retaining portion so as to retain the fish attracting article in the retaining portion.

According to yet another embodiment of the present invention, the lure comprises an elastomeric body defining an aperture having an entrance portion and a retaining portion. The entrance portion is structured to allow passage of the fish attracting article therethrough into the retaining portion. The entrance portion and the retaining portion intersect to form at least one shoulder structured to retain the at least one fish attracting article in the retaining portion. In one embodiment, the at least one shoulder is formed by the retaining portion having a diameter larger than the diameter of the entrance portion. In another embodiment, the at least one shoulder is formed by an angle between the axis of the retaining portion and the axis of the entrance portion. For example, in one embodiment the axis of the entrance portion is disposed at an angle of between about 0° and 90° relative to the axis of the retaining portion. In still another embodiment, the entrance portion has an end coincident with one end of the retaining portion.

The present invention also provides a method of constructing a fishing lure. The method includes providing an elastomeric body defining an aperture having an entrance portion and a retaining portion. A fish attracting article is inserted into the entrance portion of the aperture. The fish attracting article is advanced to a shoulder defined at the intersection between the entrance portion and the retaining portion. The fish attracting article is then further advanced past the shoulder and into the retaining portion of the aperture such that the shoulder restricts egress of the fish attracting article into the entrance portion of the aperture. In one embodiment, the orientation of the fish attracting article is modified concurrently with the second advancing step. In another embodiment, the lure is attached to a fishing line. In yet another embodiment, the fish attracting article is removed from the aperture. The inserting and first and second advancing steps can then be repeated to insert a replacement fish attracting article.

The present invention has several advantages. Generally, the soft body of the lure gives it an appearance and feel that is more like live bait than rigid artificial lures. These qualities, in combination with a range of selectable fish attracting articles, such as illuminants, scent packets or rattles, increase the attractiveness of the lure to fish. The aperture defined by the elastomeric body effectively retains the fish attracting article even during vigorous casting or retrieving a thrashing fish. In addition, the structure and positioning of the aperture allows for easy insertion and removal of fish attracting articles thereby minimizing tearing of the elastomeric body. The use of a crystal gel to construct the elastomeric body further minimizes the risk of tearing. Accordingly, the lure of the present invention provides the angler with a lure body that is elastic enough to be realistic and that can effectively retain a variety of fish attracting articles, which can be inserted and removed from the body with minimal risk of initiating a tear or other damage.

### BRIEF DESCRIPTION OF THE DRAWINGS

The foregoing and other advantages and features of the invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is an exploded view illustrating a fish attracting article and a lure body defining an aperture therein for retaining the fish attracting article, according to one embodiment of the present invention;

FIG. 2 is a bottom plan view illustrating the lure body of FIG. 1;

FIG. 3 is an exploded view illustrating a fish attracting article and a lure body defining an aperture therein for retaining the fish attracting article, according to another embodiment of the present invention;

FIG. 4 is a top plan view illustrating the lure body of FIG. 3;

FIG. 5 is an exploded view illustrating a fish attracting article and a lure body defining an aperture therein for retaining the fish attracting article, according to another embodiment of the present invention;

FIG. 6 is a cross sectional view of a rattle for attracting fish, according to one embodiment of the present invention, the rattle being adapted for insertion into the aperture of the lure bodies of FIGS. 1-5; and

FIG. 7 is a flow chart illustrating the operations performed to construct a fishing lure, according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

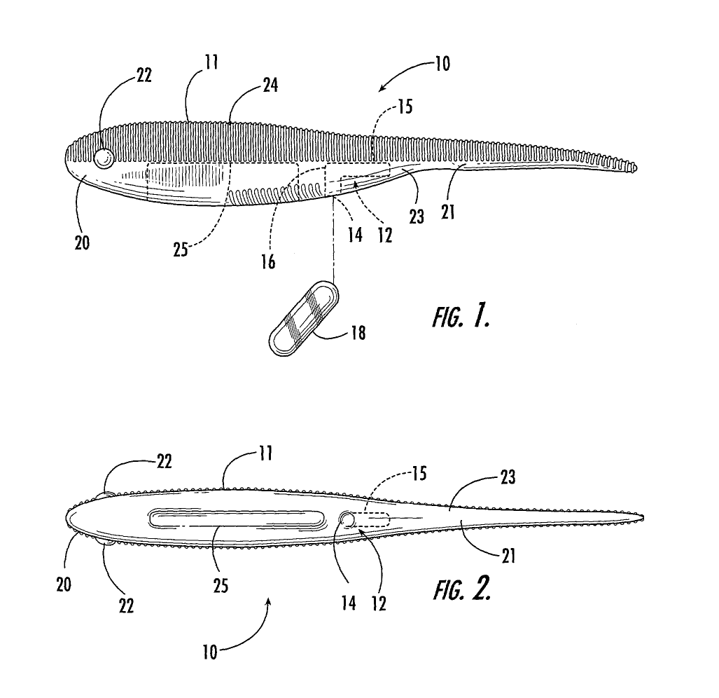

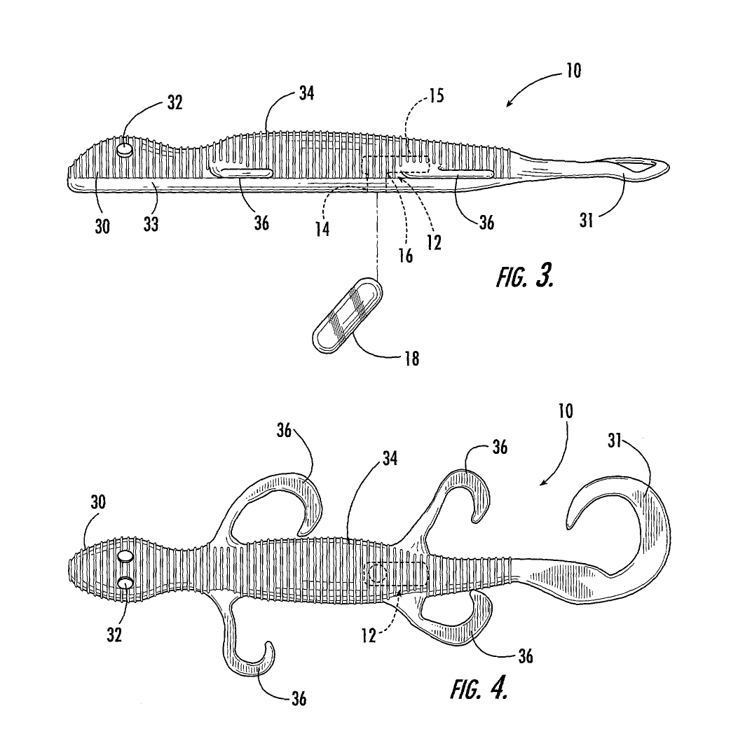

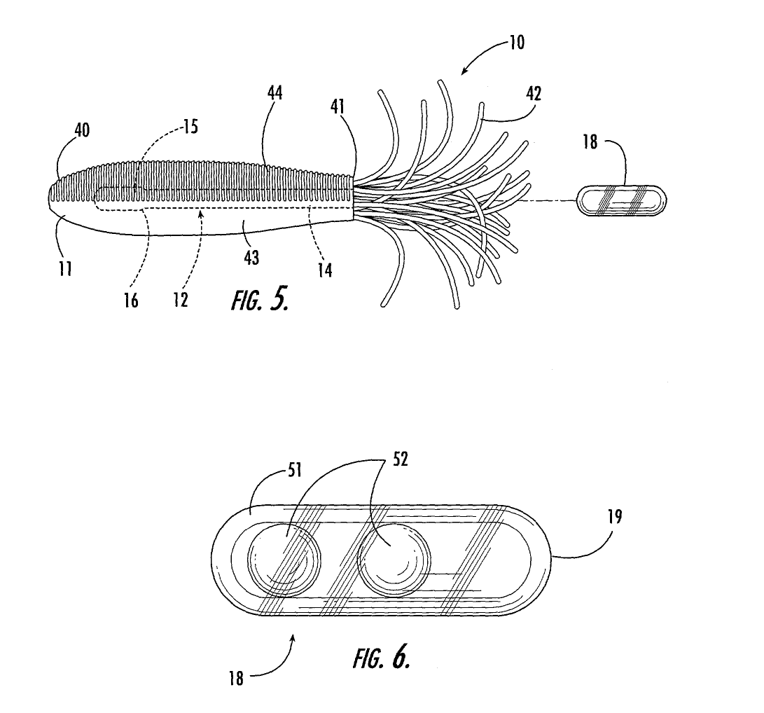

Referring to the drawings, and in particular, to FIGS. 1-5, there are shown fishing lures 10, according to three embodiments of the present invention. Each lure 10 includes an elastomeric body 11 defining an aperture 12 therein for holding and retaining at least one fish attracting article 18, such as the rattle 19 illustrated in FIG. 6. Other fish attracting articles 18 include illuminants, such as light sticks or light-emitting diodes (“LEDs”); scent packets or capsules; gas emitters, such as gas emitting, aeration, or effervescent products or devices; or weights. The body 11 can be formed or molded into a variety of configurations in order to customize the lure 10 to the particular bait characteristics of the target fish. For purposes of example only and not limitation, the body 11 can be molded into a fish-like or minnow-like configuration, as illustrated in FIGS. 1 and 2; a salamander-like or lizard-like configuration, as illustrated in FIGS. 3 and 4; a worm-like or squid-like configuration, as illustrated in FIG. 5; a crawfish-like configuration (not shown), a frog-like configuration (not shown), or a tube-like configuration (not shown). Other configurations also are possible and considered to be within the scope of the present invention. In addition to the shape and size of the body 11, the coloring, opacity and texture of the body also can be varied depending on the particular bait characteristics of the target fish.

According to one embodiment, as illustrated in FIGS. 1 and 2, a body 11 molded into a fish-like or minnow-like configuration can be provided with a head 20 and a tail 21 and can include a pair of eyes 22, which are molded on opposite sides of the head 20. As illustrated in FIG. 1, the coloring of the body 11 can be a “two-tone” pattern in which the topside or dorsal surface 24 has a darker color than the underside or abdomen 23. In other embodiments, the body 11 can be monochromatic or mulitcolored with varying patterns, such as spotted, speckled, mottled, or striped. The body 11 also can be formed of a material having a relatively low opacity. In addition to coloring and opacity, the body 11 can be molded so as to provide any desired texturing. As illustrated in FIG. 1, the topside or dorsal surface 24 has a ribbed texture whereas the underside or abdomen 23 is relatively smooth. Advantageously, the dark patterned dorsal surface 24 of the lure 10 illustrated in FIG. 1 mimics the generally darker scales present on the dorsal surface of many bait fish species. Other types of texturing are also possible. As illustrated in FIGS. 1 and 2, an optional hook slot 25 and cavity 25a can be defined in the abdominal surface 23 and interior of the body 11, respectively, so as to conceal from the target fish a hook (not shown) inserted therein. Other features can be included on the fish-like body 11 to increase its realism, such as dorsal and tail fins (not shown).

According to another embodiment, as illustrated in FIGS. 3 and 4, a body 11 molded into a salamander-like configuration can be provided with a head 30 and a tail 31 and can include a pair of eyes 32, which are molded on top of the head 30. The tail 31 preferably is relatively thin with an elongate and curvilinear shape allowing it to flutter as the lure 10 is pulled through the water to thereby give the lure the impression of motion. The body 11 can include four legs 36 extending therefrom. As with the tail 31, each of the legs 36 preferably is relatively thin with an elongate and curvilinear shape allowing it to flutter as the lure 10 is pulled through the water to give the impression of motion. As with the lure 10 in FIG. 1, the coloring of the body 11 illustrated in FIG. 3 is a “two-tone” pattern in which the dorsal surface 34 has a darker color than the abdomen 33. In other embodiments, the body 11 can be monochromatic or mulitcolored with varying patterns, such as spotted, speckled, mottled, or striped. The body 11 also can be formed of a material having a relatively low opacity. As illustrated in FIG. 4, the dorsal surface 34 has a ribbed texture whereas the abdomen 33 is relatively smooth. Other types of texturing are also possible, for example, both the dorsal surface 34 and abdomen 33 can be relatively smooth or ribbed.

According to yet another embodiment, as illustrated in FIG. 5, the body 11 of the lure 10 has a worm-like or squid-like configuration, including a head 40 and a tail 41. A plurality of streamers 42 preferably extend from the tail 41, which flutter as the lure 10 is pulled through the water to give the lure the impression of motion. As with the lures 10 in FIGS. 1 and 3, the coloring of the body 11 illustrated in FIG. 5 is a “two-tone” pattern in which the dorsal surface 44 has a darker color than the abdomen 43. In other embodiments, the body 11 can be monochromatic or mulitcolored with varying patterns, such as spotted, speckled, mottled, or striped. The body 11 can also be formed of a material having a relatively low opacity. The dorsal surface 44 has a ribbed texture whereas the abdomen 43 is relatively smooth. Other types of texturing are also possible, for example, both the dorsal surface 44 and abdomen 43 can be relatively smooth or ribbed.

It should be noted that the aforementioned body 11 configurations are meant to be illustrative of the range of body configurations possible according to the present invention and are not meant to be limiting. For instance, various other configurations, colors, patterns, textures and/or appendages could be used to create different effects that imitate natural bait. The body 11 of the lure 10 also may only be a portion of the entire lure. More specifically, a soft elastomeric body 11 or “tail” could be used with a hard plastic, wood or metal head. In addition, various colors, pigments, metal flakes, scents and other additives can be added to the elastomeric material of the body 11 so as to increase its attractiveness to fish.

The elastomeric materials used to form the body 11 of the present invention are preferably comprised of styrene-ethylene-butylene-styrene (“SEBS”) triblock copolymer gels. More specifically, the body is preferably constructed from SEBS triblock and (SEB)ₙ, radial copolymers with crystalline ethylene-butylene elastomer midblock segments referred to as “crystalline midblock gels” or “crystal gels,” as described more fully in U.S. Pat. Nos. 5,884,639; 6,117,176; 6,148,830 and 6,161,555 all to Chen and all of which are hereby incorporated herein in their entirety by reference. The improved properties of the crystal gels over amorphous gels include improved damage tolerance, crack propagation resistance, tear resistance and fatigue resistance. For example, the crystal gels can exhibit an elongation at failure of between about 1,600% and 3,000% and higher, an ultimate tensile strength of about 8×10⁵ dyne/cm², and substantial shape memory even when subjected to an elongation of approximately 1,200%. While not intending to be bound by any particular theory, it is believed that the improved properties of crystal gels over amorphous gels are a result of the cross-linking crystalline structures inhibiting crack or tear propagation.

The crystal gels can also be modified to have different properties, many of them useful for increasing the attractiveness of lures. For instance, the crystal gels can contain useful amounts of conventionally employed additives such as colorants, fragrances, flavors or other polymers in minor amounts without affecting or substantially decreasing the desired properties. Further, the crystal gels can contain metallic pigments, such as aluminum and brass flakes, and fluorescent dyes or pigments. As a result, the crystal gels can have most, if not all, of the desirable characteristics of elastomers previously used to construct soft bodied fishing lures, but with improved tear, fatigue, crack and general damage resistance. It should be noted, however, that although crystal gels are preferred for constructing the body 11 of the lure 11 due to the above-mentioned properties, other elastomeric materials and polymers could also be used in lieu of the crystal gels.

As illustrated in FIGS. 1-5, the aperture 12 defined by the body 11 for retaining the fish attracting articles 18 includes an entrance portion 14 and a retaining portion 15. The entrance portion 14 of the aperture 12 preferably has an end coincident with one end of the retaining portion 15. However, the entrance portion 14 also can intersect the retaining portion 15 at the midpoint of the retaining portion or at another point along the length of the retaining portion. The entrance portion 14 of the aperture 12 is structured for receiving and passing the fish attracting article 18 therethrough and into the retaining portion 15. More specifically, the entrance portion 14 preferably has a diameter sufficiently large to allow the fish attracting article 18 to pass through without tearing the body 11. The size and shape of the retaining portion is likewise structured for receiving the fish attracting article 18. Where the body 11 is molded into a configuration of prey, such as the fish-like or minnow-like configuration illustrated in FIGS. 1 and 2, or the salamander-like configuration illustrated in FIGS. 3 and 4, the entrance portion 14 of the aperture 12 can be positioned on the abdomen of the body 11 so that the aperture will have an anatomically correct appearance.

Advantageously, the aperture 12 defines one or more shoulders 16 at the intersection of the entrance portion 14 and the retaining portion 15 to retain the fish attracting article 18 in the retaining portion and restrict egress of the article back into the entrance portion. In one embodiment, the at least one shoulder 16 is formed by the axis of the entrance portion 14 being disposed angularly relative to the axis of the retaining portion 15. The angle between the axis of the entrance portion 14 and the axis of the retaining portion 15 can vary between about 0° and about 350°, depending on the dimensions and configuration of the body 11. For example, as illustrated in FIG. 1, the axis of the entrance portion 14 is disposed at an angle of approximately 90° to the axis of the retaining portion 15. As illustrated in FIG. 3, the axis of the entrance portion 14 is disposed at an angle of approximately 60° to the axis of the retaining portion 15. As illustrated in FIG. 5, the axis of the entrance portion 14 is disposed at an angle of approximately 0° to the axis of the retaining portion 15.

For angles between about 10° and about 170° and between about 190° and about 350°, the entrance portion 14 and the retaining portion 15 of the aperture 12 can have the same or different diameters. The size of the diameter will depend on the material used to form the body 11, but should be large enough so that the fish attracting article 18 will pass through the entrance portion 14 into the retaining portion 15 without tearing yet small enough that the article will be retained in the retaining portion with the aid of the shoulder 16.

In another embodiment, as illustrated in FIG. 5, the at least one shoulder 16 is formed by the diameter of the retaining portion 15 being larger than the diameter of the entrance portion 14. The smaller diameter of the entrance portion 14 forms the shoulder 16, which urges the fish attracting article 18 into the retaining portion 15. This embodiment is particularly advantageous when the axis of the entrance portion 14 and the axis of the retaining portion 15 are roughly co-linear, such as the worn-like or squid-like body 11 illustrated in FIG. 5. Apertures 12 having a relatively co-linear entrance portion 14 and retaining portion 15 are useful when the body 11 configuration of the lure 10 has a small cross-sectional area and/or a relatively elongate shape. As illustrated in FIG. 5, the entrance portion 14 of the aperture 12 extends from the tail 41 to one end of the retaining portion 15. Optionally, the tail 41 of the body 11 can include a plurality of streamers 42 to conceal the opening of the entrance portion 14.

Although the various aperture 12 configurations are each illustrated in the context of a particular body 11 configuration, the different aperture configurations can be used in any type of soft-bodied lure of sufficient size to receive and hold the fish attracting article 18.

Referring to FIG. 6, there is illustrated one type of fish attracting article 18, a rattle 19. The rattle 19 preferably includes a cylindrical glass or plastic tube 51 with blunt, closed ends housing a pair of metal beads 52. Movement of the glass tube causes the beads to reciprocate and make a clicking noise. Other types of rattles 13 also can be used in the present invention to make fish attracting noises, including rattles with three or more beads, or with beads constructed of different materials such as ceramic or glass. As discussed above, other types of fish attracting articles 18 may be used such as lights sticks or other illuminants or scent packets that are easily inserted and firmly held in the various aperture 12 configurations and body 11 configurations of the lures 10 of the present invention.

Preferably, each lure body 11 is formed in a mold (not shown) configured to have the desired body 11 configuration and including any desired texturing or other surface details, such as the patterned dorsal surfaces 24, 34, 44 illustrated in FIGS. 1 and 3-5. Use of a mold also facilitates formation of the aperture 12 so as to avoid later steps of cutting or drilling the aperture. Specifically, a projection inside the mold having a shape and size corresponding to the desired shape and dimensions of the entrance portion 14 and the retaining portion 15 of the aperture 12 can be used to form the aperture in the body 11 of the lure 12. At elevated temperatures the elastomeric material and crystal gel are liquid, allowing them to be dispensed into the mold. Once dispensed, the mold and the elastomeric material or crystal gel are allowed to cool so that the body 11 of the lure 10 sets. Once set, the elastomeric properties of the body 11 allow it to be easily removed from the mold.

Referring to FIG. 7, there are illustrated the operations for constructing a lure 10, according to one embodiment of the present invention. The method includes providing an elastomeric body defining an aperture having an entrance portion and a retaining portion. See Block 60. A fish attracting article is inserted into the entrance portion of the aperture. See Block 61. For example, the angler grips the lure 10 in one hand and uses the other hand to grip the fish attracting article 18. The fish attracting article is advanced to a shoulder defined at the intersection between the entrance portion and the retaining portion. See Block 62. In this regard, because of the elasticity of the material, the angler can push one blunt end of the fish attracting article 18 into the entrance portion 14, which enlarges the diameter of the entrance portion. The fish attracting article is then further advanced past the shoulder and into the retaining portion of the aperture such that the shoulder restricts egress of the fish attracting article into the entrance portion of the aperture. See Block 63. In the case of a shoulder 16 formed by an angle between the axes of the entrance portion 14 and retaining portion 15 of the aperture 12, the fish attracting article 18 is angled in the direction of the retaining portion 15 and pushed further into the aperture 12 until fully in the retaining portion 15. In the case of a shoulder 16 formed by a change in diameter between the entrance portion 14 and retaining portion 15 of the aperture 12, the fish attracting article 18 is advanced linearly until in the retaining portion 15. Once in the retaining portion 15, the shoulder 16 urges the fish attracting article 18 to remain in the same position. In one embodiment, the orientation of the fish attracting article is modified concurrently with the second advancing step. See Block 64. In another embodiment, the lure is attached to a fishing line. See Block 65.

The angler can remove the fish attracting article 18 by pushing on the article from outside of the body 11, forcing the article past the shoulder 16 until one end becomes visible in the entrance portion 14. See Block 66. The angler may then grip the visible end of the fish attracting article 18 and complete its removal. The insertion and first and second advancing steps can then be repeated to insert a replacement fish attracting article 18 into the retaining portion 15 of the aperture 12.

The present invention has several advantages. Generally, the soft body 11 of the lure allows it to move and feel more like live bait than hard lures. These qualities, in combination with a range of selectable fish attracting articles 18, such as illuminants, scent packets or rattles 13, increase the attractiveness of the lure 10 to fish. The shoulder 16 defined by the aperture 12 of each of the embodiments, whether from a change in diameter between, or the angular disposition of the axes of, the entrance and retaining portions 14, 15, effectively retains the fish attracting article 18 in the retaining portion. The continuity of the entrance and retaining portions 14, 15 of the aperture 12 allows for easy insertion and retrieval of the fish attracting articles 18. Tearing of the soft plastic body is minimized by the ease of retrieval and replacement of the fish attracting articles 18 in the retaining portion 15 of the aperture 12, and is further minimized by use of crystal gels, which have improved damage tolerance, crack propagation resistance, tear resistance and fatigue resistance. Thus, the lure of the present invention presents the angler with a body 11 elastic enough to be realistic, yet tough enough to resist tearing. This realism is enhanced by the ability to use various fish attracting articles 18 that are firmly held in the retaining portion 15 of the aperture 12 defined by the body 12, and which can be replaced as desired with minimal risk of initiating a tear or other damage to the body.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A lure configured to hold a fish attracting article so as to increase the attractiveness of the lure to fish, the lure comprising:
an elastomeric body defining an aperture having an entrance portion and a retaining portion, said entrance portion having an end coincident with one end of said retaining portion and being structured to allow passage of the fish attracting article therethrough into said retaining portion, and wherein the axis of said entrance portion is disposed angularly relative to the axis of said retaining portion to thereby retain the fish attracting article in said retaining portion.

2. The lure according to claim 1 wherein said elastomeric body comprises a crystal gel.

3. The lure according to claim 1 wherein the axis of said entrance portion is disposed at an angle of between about 0° and 90° relative to the axis of said retaining portion.

4. The lure according to claim 1 wherein said elastomeric body defines a salamander-like configuration.

5. The lure according to claim 4 wherein said entrance portion of said aperture is positioned at the abdomen of said salamander-like configuration.

6. The lure according to claim 1 wherein said elastomeric body defines a fish-like configuration.

7. The lure according to of claim 6 wherein said entrance portion of said aperture is positioned at the abdomen of said fish-like configuration.

8. A lure configured to hold a fish attracting article so as to increase the attractiveness of the lure to fish, the lure comprising:
an elastomeric body defining an aperture having an entrance portion and a retaining portion, wherein the diameter of said entrance portion is approximately equal to the diameter of said retaining portion, said entrance portion being structured to allow passage of the fish attracting article therethrough into said retaining portion, and wherein the axis of said entrance portion is disposed angularly relative to the axis of said retaining portion to thereby retain the fish attracting article in said retaining portion.

9. The lure according to claim 8 wherein said elastomeric body comprises a crystal gel.

10. The lure according to claim 8 wherein the axis of said entrance portion is disposed at an angle of between about 0° and 90° relative to the axis of said retaining portion.

11. The lure according to claim 8 wherein said entrance portion has an end coincident with one end of said retaining portion.

12. The lure according to claim 8 wherein said elastomeric body defines a salamander-like configuration.

13. The lure according to claim 12 wherein said entrance portion of said aperture is positioned at the abdomen of said salamander-like configuration.

14. The lure according to claim 8 wherein said elastomeric body defines a fish-like configuration.

15. The lure according to of claim 14 wherein said entrance portion of said aperture is positioned at the abdomen of said fish-like configuration.

16. A lure configured to hold a fish attracting article so as to increase the attractiveness of the lure to fish, the lure comprising:
an elongate elastomeric body;
wherein said elongate elastomeric body defines an aperture having an entrance portion and a retaining portion, said entrance portion of said aperture extending from one end of said elongate elastomeric body to one end of said retaining portion, and wherein the diameter of said entrance portion is smaller than the diameter of said retaining portion so as to retain the fish attracting article in said retaining portion.

17. The lure according to claim 16 wherein said elastomeric body comprises a crystal gel.

18. The lure according to claim 16 further comprising a plurality of streamers extending from said elongate elastomeric body so as to conceal said entrance portion.

19. The lure according to claim 16 wherein said entrance portion and said retaining portion of said aperture are substantially axially aligned.

20. A lure for attracting a fish, the lure comprising:
at least one fish attracting article;
an elastomeric body defining an aperture having an entrance portion and a retaining portion, said entrance portion being structured to allow passage of said fish attracting article therethrough into said retaining portion; and
wherein said entrance portion and said retaining portion intersect to form at least one shoulder, said at least one shoulder being structured to retain said fish attracting article in said retaining portion.

21. The lure according to claim 20 wherein said at least one shoulder is formed by said retaining portion having a diameter larger than the diameter of said entrance portion.

22. The lure according to claim 20 wherein said at least one shoulder is formed by an angle between the axis of said retaining portion and the axis of said entrance portion.

23. The lure according to claim 20 wherein said at least one fish attracting article comprises an article selected from the group consisting of a rattle, an illuminant, a scent packet, a gas emitter, and a weight.

24. The lure according to claim 20 wherein said entrance portion has an end coincident with one end of said retaining portion.

25. The lure according to claim 20 wherein said elastomeric body comprises a crystal gel.

26. The lure according to claim 20 wherein the axis of said entrance portion is disposed at an angle of between about 0° and 90° relative to the axis of said retaining portion.

27. The lure according to claim 20 wherein said elastomeric body defines a salamander-like configuration.

28. The lure according to claim 27 wherein said entrance portion of said aperture is positioned at the abdomen of said salamander-like configuration.

29. The lure according to claim 20 wherein said elastomeric body defines a fish-like configuration.

30. The lure according to claim 15 wherein said entrance portion of said aperture is positioned at the abdomen of said fish-like configuration.

31. A method of constructing a fishing lure, comprising:
providing an elastomeric body, the body defining an aperture having an entrance portion and a retaining portion;
inserting a fish attracting article into the entrance portion of the aperture;
advancing the fish attracting article to a shoulder defined at the intersection between the entrance portion and the retaining portion; and
further advancing the fish attracting article past the shoulder and into the retaining portion of the aperture such that the shoulder restricts egress of the fish attracting article into the entrance portion of the aperture.

32. A method according to claim 31 further comprising modifying the orientation of the fish attracting article concurrently with said second advancing step.

33. A method according to claim 31 further comprising attaching the lure to a fishing line.

34. A method according to claim 31 further comprising removing the fish attracting article from the aperture.

35. A method according to claim 34 further comprising repeating the inserting and first and second advancing steps to insert a replacement fish attracting article.
